(19) United States
(12) Patent Application Publication
(10) Pub. No.: US 2007/0053291 A1
(43) Pub. Date: Mar. 8, 2007

(54) Optimized Broadcast of ESG with Simple Fragment Management Scheme

(75) Inventors: Reino Juhani Hiltunen, Merimasku (FI); Jani Poikela, Helsinki (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/470,516

(22) Filed: Sep. 6, 2006

Related U.S. Application Data
(60) Provisional application No. 60/713,721, filed on Sep. 6, 2005.

(51) Int. Cl. H04J 3/14

(52) U.S. Cl. 370/233

(57) ABSTRACT

Provided are apparatuses and methods in a digital broadcast transmission system for managing ESG fragments of a service guide at a receiver or subscriber terminal. In one example of the invention, an ESG fragment containing one of a start time or a stop time of a corresponding program or service is received at a subscriber terminal or receiver. The receiver may compare the start time and/or stop time with a current time. Based on the comparison, the ESG fragment may be stored in memory. If an ESG fragment is stored in memory and a subsequent corresponding ESG fragment is received, then based on the comparison step, the receiver may delete the ESG fragment in memory or maintain the ESG fragment in memory.

### CROSS REFERENCE TO RELATED APPLICATIONS

This application claims the benefit of U.S. Provisional Application No. 60/713,721, which was filed Sep. 6, 2005, and which is incorporated herein by reference.

### FIELD OF THE INVENTION

The invention relates generally to communications networks. More specifically, the invention provides for management of transmitted and received data in a service guide.

### BACKGROUND OF THE INVENTION

Generally, an Electronic Service Guide (ESG) enables a terminal to communicate what services are available to end users and how the services may be accessed. ESG fragments are independently existing pieces of the ESG. Traditionally, ESG fragments comprise XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting. The ESG data may be transmitted using different types of wireless digital networks including digital broadband broadcast and/or multicast networks.

A service provider provides information on current or future services or content by transmission of corresponding ESG fragments in a data stream to a subscriber terminal. The ESG fragments received at the subscriber terminal may be stored locally. When the availability of the service or content is over, the corresponding ESG fragments are no longer transmitted from the service provider. As a result, the corresponding ESG fragments are removed from storage in the subscriber terminal.

The service provider utilizes resources and bandwidth to transmit the ESG fragments. However, in many systems, the service provider must continuously transmit the ESG fragment to the subscriber terminal. The subscriber terminal may store the received ESG fragments; however, if the ESG fragment is not continuously received from the service provider, the subscriber terminal in these systems may determine that the service corresponding to the ESG fragment has terminated and that the ESG fragment is to be deleted. This may result in premature deletion of desired information.

Thus, there is a need for a broadcast system in which a transmitter delivers data to a subscriber terminal while conserving resources. There is also a need for a broadcast system in which a receiver or subscriber terminal can manage received data and ESG fragments from a transmitter or service provider such that desired information is available and not prematurely deleted. There is also a need for a receiver or subscriber terminal that can receive multiple ESG fragments from a broadcast channel and an interaction channel and combine the fragments into a service guide.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a transmitter is provided that creates an ESG fragment associated with a program or service. The ESG fragment may include a start time or a stop time associated with the program or service. For example, the start time or stop time may indicate the planned start time or time of completion of the program or service, or there may be separate start and end times for that purpose. The transmitter may further transmit the ESG fragment over a variety of networks.

In another example, a receiver or subscriber terminal is provided that receives an ESG fragment. The receiver may manage or store the received ESG fragment. The ESG fragments received at the receiver may include a start time and/or a stop time associated with a corresponding program or service. The receiver may further delete the stored ESG fragment based on the presence or absence of the ESG fragment in the received ESG transmission and/or based on the start and/or stop times.

In another example, a method is provided for managing the storage and deletion of ESG fragments at a receiver or subscriber terminal.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless communication system in which various aspects of the present invention may be implemented.

FIG. 2 illustrates a suitable digital broadcast receiver in which one or more illustrative embodiments of the invention may be implemented.

FIG. 3 illustrates a schematic diagram of an example of a transport object in which one or more illustrative embodiments of the invention may be implemented.

FIG. 4 illustrates examples of transporting single transport objects in which on or more illustrative embodiments of the invention may be implemented.

FIG. 5 is a block diagram illustrating partially an example of a transmitter for transmitting service guide data in which one or more illustrative embodiments of the invention may be implemented.

FIG. 6 is a block diagram illustrating partially an example of a subscriber terminal or receiver for receiving a service guide in which one or more illustrative embodiments of the invention may be implemented.

FIG. 7 illustrates an example of creating an ESG associated with a program and transmitting the ESG fragment to a subscriber terminal or receiver in which one or more illustrative embodiments of the invention may be implemented.

FIG. 8 is a general overview of an example of ESG fragments being transmitted over a period of time in a service guide in which one or more illustrative embodiments of the invention may be implemented.

FIG. 9 illustrates an example of a service bundle providing multiple services including ESG services in which one or more illustrative embodiments of the invention may be implemented.

FIG. 10 illustrates an example of transmission of ESG fragments corresponding to different types of ESGs over a period of time in which one or more illustrative embodiments of the invention may be implemented.

FIG. 11 is a diagram illustrating an example of transmitting ESG fragments of a service in which one or more illustrative embodiments of the invention may be implemented.

FIG. 12 is a flowchart illustrating an example of a method for managing ESG fragments in which one or more illustrative embodiments of the invention may be implemented.

FIG. 13 is a diagram illustrating main elements of the ESG data model in DVB

FIG. 14 is a diagram illustrating main elements of the ESG data model in OMA BCAST.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

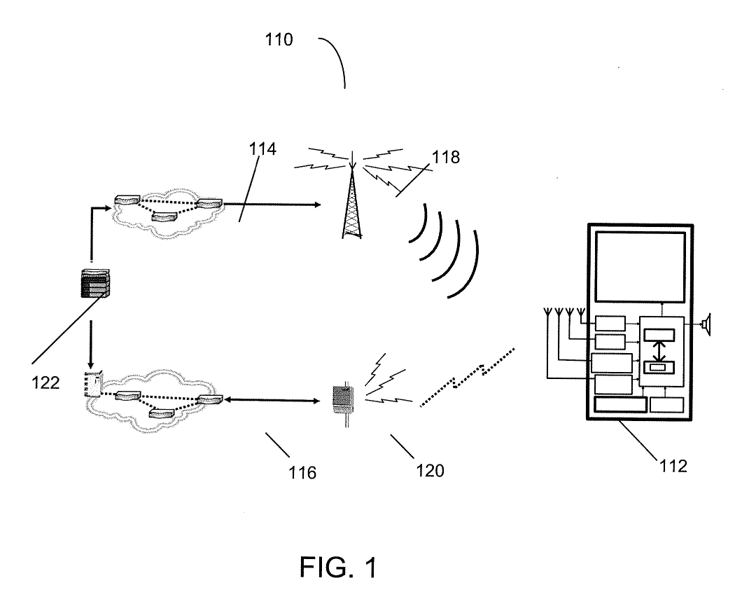

Embodiments of the invention may be utilized across a broad array of networks and communication protocols. FIG. 1 illustrates an example of a wireless communication system 110 in which the systems and methods of the invention may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, AM/FM radio service providers, SMS/MMS push service providers, Internet content or access providers.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H), a recently developed technology that increases the capabilities and services available on small handheld devices, such as mobile telephones. The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, may be incorporated into the TS. This enables a receiver device to correctly process the data contained within the TS.

Embodiments of the invention, however, are also applicable to other traditional digital mobile broadcast systems such as, for example, T-DAB, T/S-DMB, ISDB-T, ATSC, MediaFLO, and non-traditional systems such 3GPP MBMS and 3GPP2BCMCS, to name a few.

The broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), a Universal Mobile Telecommunications System (UMTS) or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

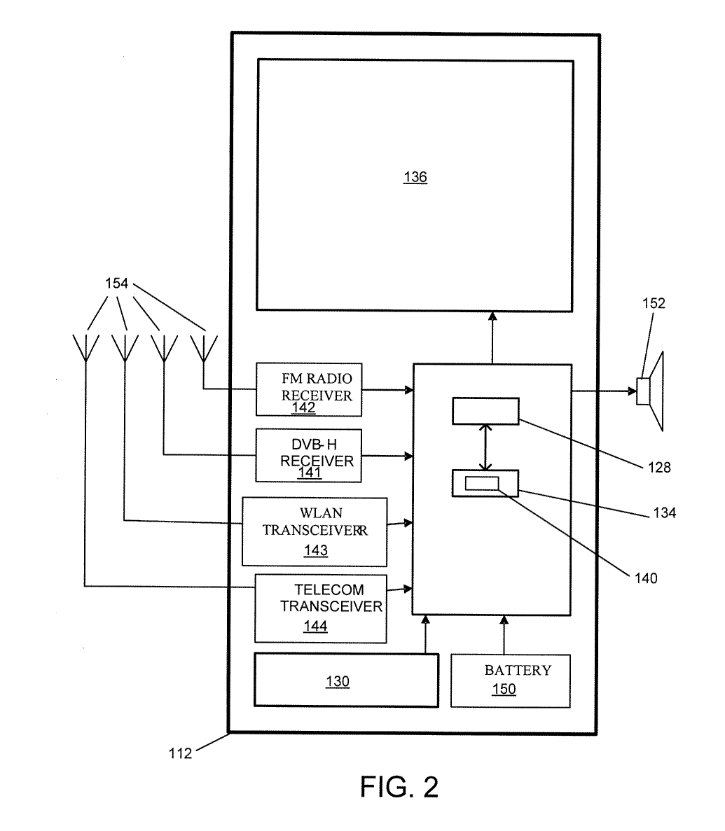

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, four arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based for example on the Digital Video Broadcast (DVB) standard, such as DVB-H or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

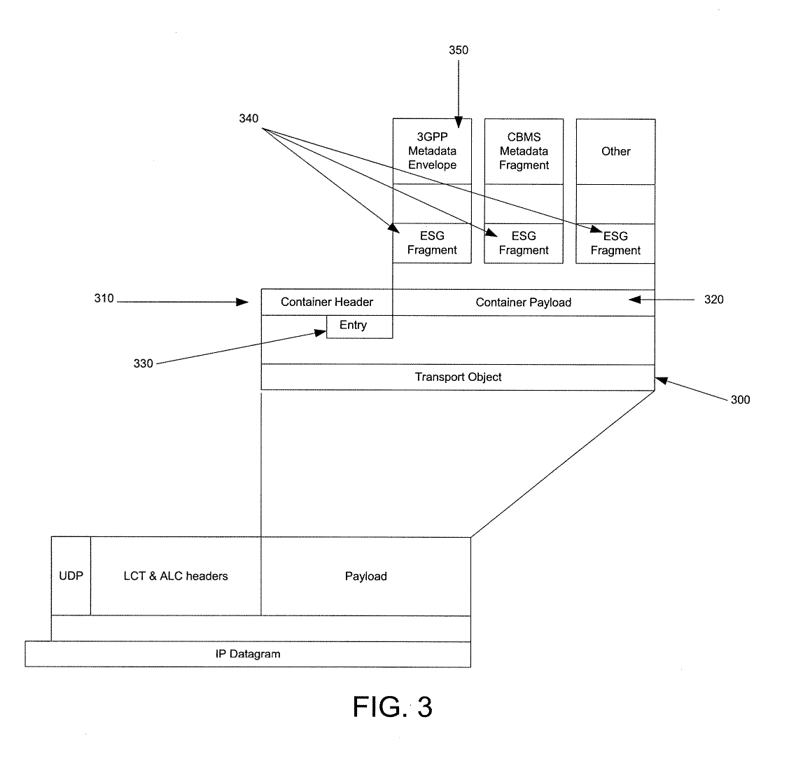

ESG fragments may be delivered in a transport object which may transport ESG information in a container. Thus, ESG fragments may be placed in a container that may be delivered in its own transport object. The container may further include a container header and a container payload, for example, in which the container header may provide information on where each container is located within the transport object. In one example, the transport object may contain a single container or a plurality of containers, each container including at least one ESG fragment. FIG. 3 is a schematic diagram of an example of a transport object in accordance with at least one aspect of the present invention. Generally, a single transport object 300 comprises a container header 310 and a container payload 320. By incorporating the header 310 and the payload 320 into a single transport object 300, there is no need to recombine each header with the information regarding where each container is located within different transported objects. Furthermore, there is no longer an issue of which to transmit first, as presented in previous systems. The container header 310 may contain configuration information regarding the header and/or the container payload 320. In one embodiment, the header 310 is coded to inform a receiver of the entry length of the header.

In an exemplary embodiment, the header 310 may have a plurality of ESG fragment descriptor entries 330 that identify the ESG fragments 340 in the container payload 320 so that the receiver may determine the exact position and/or length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries 330, an ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

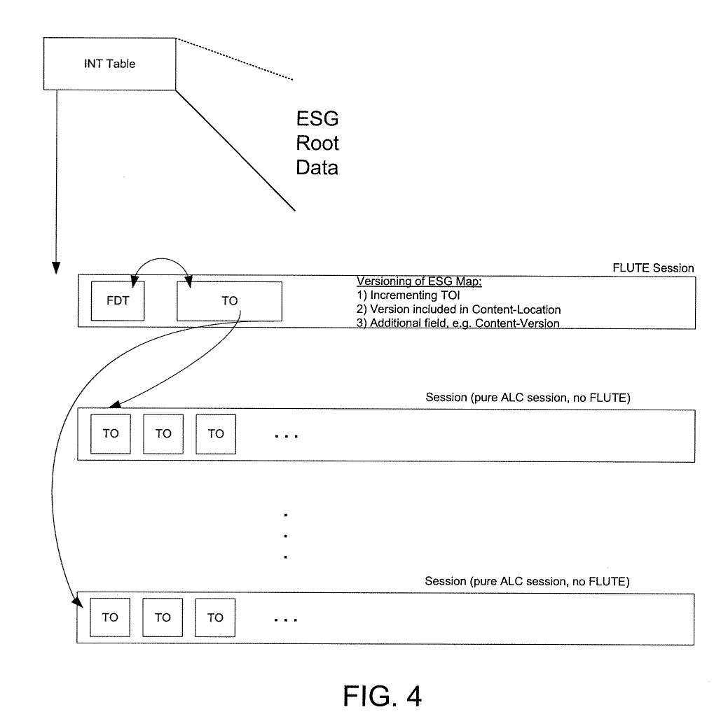

FIG. 4 illustrates an example of transmitting a plurality of single Transport Objects. As illustrated in FIG. 4, the Transport Objects (TO) of the current invention may be carried in, for example, FLUTE (File Delivery over Unidirectional Transport) sessions, or a pure Asynchronous Layered Coding (ALC) session. In the example of FIG. 4, the ESG Root Channel data, such as IP Address, port number and Transport Session Identifier (TSI), are announced in the IP/MAC Notification Table (INT Table). The FLUTE session of the ESG Root Channel comprises a File Delivery Table (FDT) of the session and one or more Transport Objects (TO). These Transport Objects in announcement carousels contain mappings between the different parts of ESGs and access parameters to the different ESG methods in which the ESG data is transmitted. The ESGs may differ from each other. For example, ESGs may be in different languages, genres or encoding.

Examples of access parameters may include, for example, IP Addresses, port numbers, TSIs, start and end times etc. The FLUTE session thus declares how the ESG data is distributed to different sessions. The TOs of the FLUTE session carrying this mapping data are described in the FDT of the FLUTE session. The ESG mapping data may be delivered in one or multiple TOs. The mapping can be made using XML Schema, plain ASCII text, Structured ASCII text such as multipart MIME or MIME headers, as binary with enumerated types or through various other means as is known in the art. The ESG data in this example may be delivered in one or more TOs, which may be within pure ALC sessions, for example. The ESG data, or parts of it, may be delivered in some embodiments of the invention in one or more FLUTE sessions in addition to, or instead of, ALC sessions.

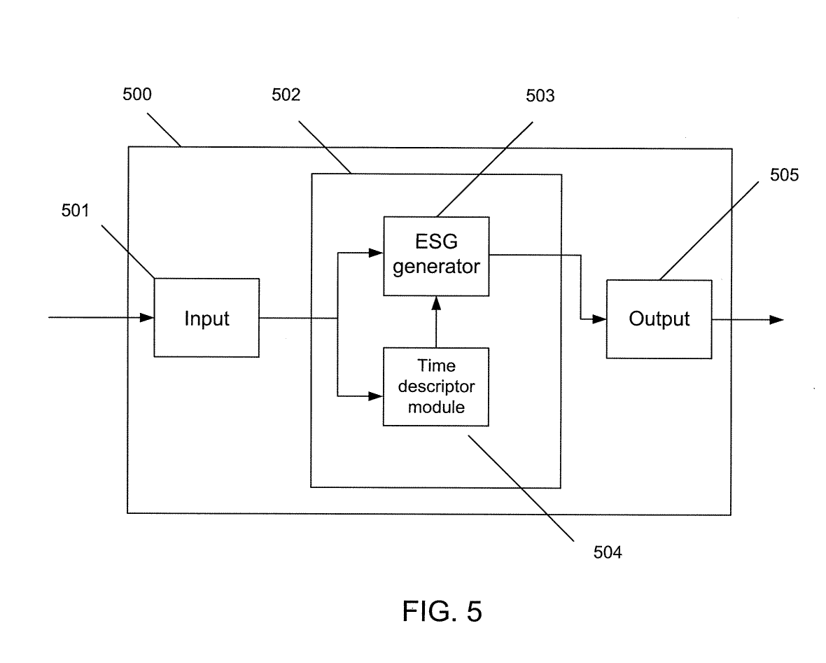

In one example of the invention, a system may provide for the scheduling of the transmission of ESG fragments in a service guide. FIG. 5 is a partial block diagram illustrating an example of a transmitter for transmitting service guide data. In this example, a transmitter 500 may include an input 501 for receiving data for a service guide transmission. Also, the input 501 of the transmitter 500 may receive information on the timing of the corresponding program content. For example, a broadcast program with a known start time and stop time may be received at the input 501. The transmitter 501 may prepare data records and ESG fragments corresponding to the broadcast program and may include within the ESG fragment or metadata of the ESG fragment the information pertaining to the start time and/or stop time of the broadcast program.

The transmitter 500 may further include a processor 502 for assembling and preparing the ESG fragment for transmission. In the example illustrated in FIG. 5, the processor 502 includes an ESG generator 503 for assembling information into an ESG fragment associated with a broadcast program for transmission. The processor 502 in this example may further include information on the start time and/or stop time of the corresponding program content in the ESG fragment as described. In this example, a time descriptor module 504 in the processor 502 may include a planned start time and/or stop time associated with a broadcast program in the transmission. In another example, the time descriptor module 504 may direct the ESG generator 503 to include the planned start time and/or stop time of the broadcast program in a corresponding ESG fragment for transmission to a subscriber terminal. The planned start time and/or stop time of the broadcast program may be included, for example, in metadata associated with the ESG fragment but can also be included in any designated portion of the ESG fragment. The ESG fragment is transmitted via an output 505.

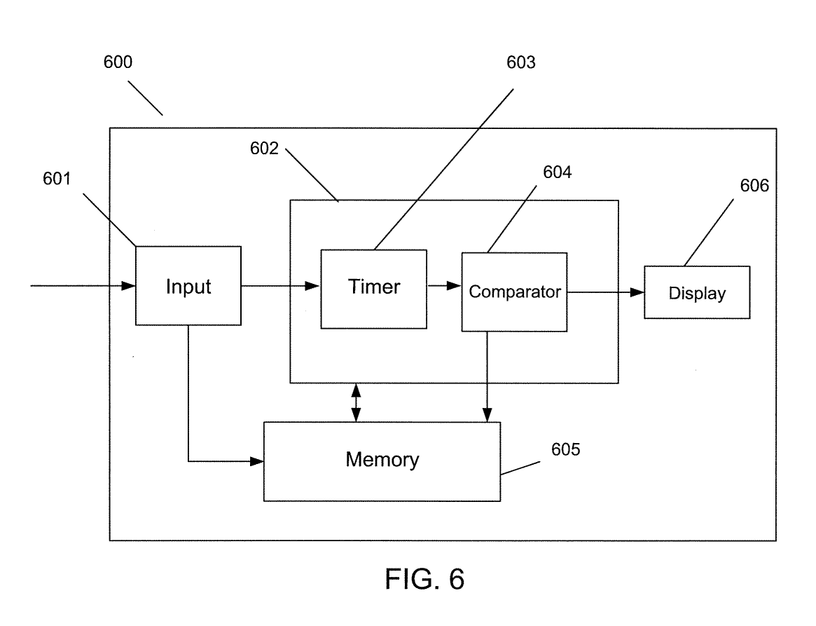

FIG. 6 is a partial block diagram illustrating an example of a subscriber terminal or receiver for receiving a service guide. In this example, the receiver 600 may include an input 601 for receiving an ESG fragment associated with a broadcast program from a transmitter of a service provider. The ESG fragment received at the input 601 may further include information on a plamied start time and/or stop time of the broadcast program. In one example, the ESG fragment is stored in memory 605 of the receiver 600. For example, if the ESG fragment is not already stored in memory 605, then the ESG fragment received at input 601 has not been previously received and stored at the receiver 600. In this case, the receiver 600 may store the ESG fragment in memory 605. Also, if a start time is provided in the ESG fragment received at input 601, the receiver may compare the start time with the current or present time. For example, a processor 602 may be included in the receiver that may compare the start time in the ESG fragment received at the input 601 with the current or present time. A timer 603 may provide the time or date which can be compared to the start time received in the ESG fragment by a comparator 604. The timer 603 and the comparator 604 are illustrated in FIG. 6 as part of the processor 602; however, the timer 603 and/or the comparator 604 may also be separate components. If the ESG fragment received at input 601 contains a start time, for example, and the processor 602, timer 603, and/or comparator 604 determines that the start time in the ESG fragment is prior to the current time from the timer 603, then the receiver may determine if the ESG fragment is previously stored in memory 605. If so, the ESG fragment may be deleted from memory 605, for example, by the processor 602 because the program associated with the ESG fragment may be determined to have expired. A more detailed description of examples of methods of management of ESG fragments is provided below.

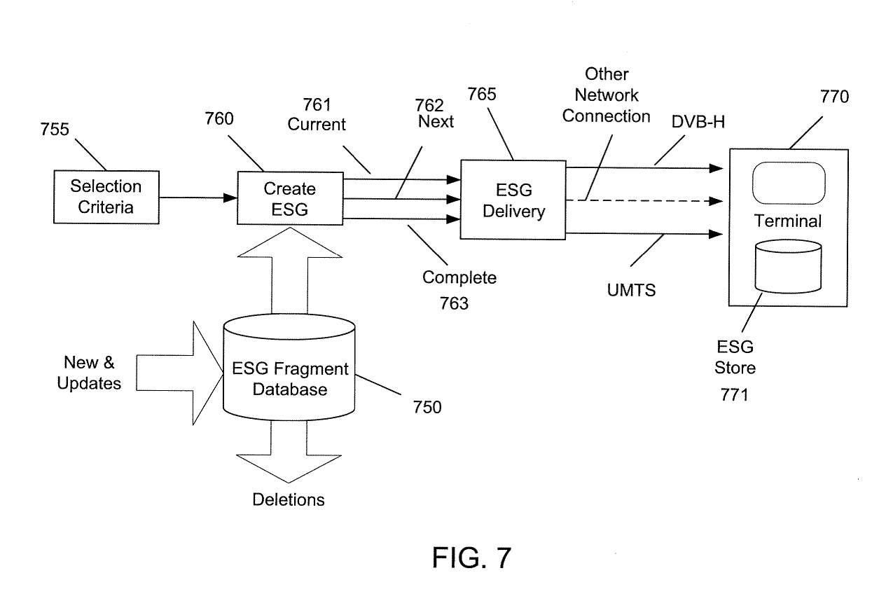

FIG. 7 illustrates an example of creating an ESG associated with a program and transmitting the ESG fragment to a subscriber terminal or receiver. In this example, a database 750 stores ESG fragment data corresponding to broadcast programs. New data corresponding to the broadcast programs may be added and old data in the database 750 may be updated with new information. Also, information may be deleted from the database 750, for example, when the program is terminated or information becomes obsolete. Selection criteria 755 may be provided such that complete or partial ESGs or ESG fragments may be created 760. The ESG fragments may be created, for example, at a transmitter of a service provider such as the transmitter illustrated in FIG. 5. The selection criteria 755 may be provided from a remote source or may be determined at the transmitter. As one example, information may be included in the broadcast program from a remote source and received at the transmitter. The transmitter may create the ESG fragment based on the information. For example, the remote source may provide the programming with a start time and/or a stop time. The transmitter may then receive the start time and/or stop time with the program data and may include the start time and/or the stop time in the ESG fragment that it creates and transmits.

The complete or partial ESGs or one or more ESG fragments that are created may be delivered 765 to a subscriber terminal or receiver 770. The ESGs and ESG fragments that are transmitted from the transmitter may differ in many respects. For example, the ESG fragments may differ in the information that they provide such as names of programs, names of performers, payment information, subscription information, etc. Also, the start time and/or stop time of ESG fragments may differ in relation to the current time as described below. FIG. 7 illustrates an example of ESG fragments providing information on services and program content over a period of time. In this example, an ESG 761 ‘current’ comprises one or more ESG fragments that may provide information on currently available services and/or content. For example, the ESG ‘current’ 761 may provide information about the nature of the services currently available, the content of programs currently available or how the programs or services can be purchased.

An ESG 762 ‘next’ comprises one or more fragments that may provide information on services or content of programs that may be received next (after the current programs), for example. In this example, the ESG 762 ‘next’ may provide information about services or broadcast programs that are not currently available but are available after the current programs. The ESG fragment 762 may further contain information on the time that the next services may be available as a current service. Also, a complete ESG 763 comprising one or more ESG fragments may be transmitted wherein it comprises information on all future programs that are planned and/or scheduled and/or described. In addition to these ‘current’, ‘next’ and ‘complete’ ESGs other combinations may be transmitted. One example of such combinations can be ESG for next four (4) hours, wherein such ESG comprises information on programs and services for next four hours.

Also, ESG fragments may be delivered in a variety of ways. For example, ESG fragments may be delivered via an ESG broadcast channel in one or more transport streams, in a DVB-H broadcast system, in a UMTS (Universal Mobile Telecommunications System) system or any other network connection. Also, the content of the ESG and ESG fragments may be downloaded by any means such as, for example, as a file download.

FIG. 7 also illustrates an example of a subscriber terminal or receiver 770. The receiver 770 may contain a storage (e.g., ESG store 771) that may store ESG and/or ESG fragment information. For example, in a DVB-H capable terminal or receiver, the receiver 770 may receive an ESG fragment and store the ESG fragment in the ESG store 771. When a subsequent ESG fragment is received at the receiver 770, the received ESG fragment is compared to the stored ESG fragments in the ESG store 771. The ESG fragment being received is processed based on the stored ESG fragments. For example, if the ESG fragment being received matches a stored ESG fragment, the ESG fragment being received need not be stored in ESG store 771. Also, if the ESG fragment being received contains a start time that is after the current time, the matching ESG fragment stored in memory may be deleted because the ESG fragment may be obsolete.

In one example, the ESG fragments are continuously transmitted from a transmitter to a receiver. The receiver may store all of the received ESG fragments in the ESG store 771. If an updated version of an ESG fragment is received at the receiver 770, the corresponding out-dated ESG fragment in the ESG store 771 is updated with the new version. This may result in continuous updating of the ESG fragments in the ESG store 771 such that the ESG fragments in the ESG store 771 are kept up-to-date and current.

In another example, the ESG fragments are continuously transmitted to the receiver 770 and are continuously stored in the ESG store 771 as they are received or used to update out-dated ESG fragments in the ESG store 771 as described. However, in this example, if ESG fragments that are stored in the ESG store 771 are not also received in the current ESG fragment transmission, then the ESG fragment stored in the ESG store 771 is deleted. Hence, in this example, only ESG fragments being received are stored and/or maintained in the ESG store. Previously stored ESG fragments are not maintained in the ESG store if the corresponding ESG fragment is not being transmitted. In this example, these ESG fragments may be deleted.

In another example, the received ESG fragments may contain data indicating the validity of the ESG fragment. If the ESG fragment is invalid based on these parameters, a corresponding ESG fragment stored in the ESG store 771 may be deleted. As one example of an invalid ESG fragment, the ESG fragment may contain an end time that is prior to the current time. In this case, the corresponding service or program has terminated and the ESG fragment is no longer in use. Therefore, the corresponding ESG fragment stored in the ESG store 771 may be deleted. These different processes are described in more detail below.

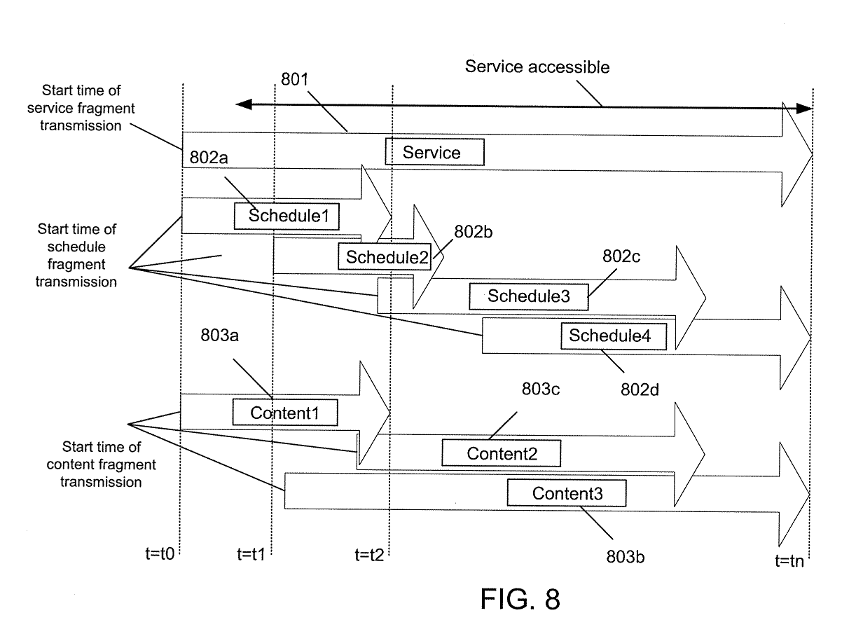

FIG. 8 is a general overview of an example of ESG fragments being transmitted over a period of time in a service guide. The example in FIG. 8 contains a plurality of ESG fragments including ESG fragment 801 relating to the service, ESG fragments relating to a schedule of transmission (802a-d, respectively) and ESG fragments relating to the contents of the transmission (803a-c, respectively). The accessibility or the transmission time of the service is also shown with an arrow. The content of the ESG fragment may provide a variety of information such as information regarding a service, information regarding a broadcast program (e.g., name, title, payment information, etc.) or how the service or program may be purchased, etc. Over a period of time, each of the ESG fragments may be transmitted to a subscriber terminal or receiver. Also, each of the ESG fragments may further include timing information corresponding to the associated service, program, etc.

In one example of the present invention, a transmission start time is provided for each ESG fragment or to a group of ESG fragments which may indicate the schedule of the corresponding program or service. The ESG fragment that is received at a terminal prior to the start time of the program or service may be stored in the terminal. The start time announced in the ESG fragment or group of ESG fragments may refer to a time in which a future service or program may be provided or a schedule described by the ESG fragment or group of ESG fragments. Prior to the start time, the service or program associated with the ESG fragment has not yet commenced. If the ESG fragment is no longer transmitted during this time period, it may indicate that the service provider has deleted the ESG fragment.

In FIG. 8 is illustrated the transmission schedule of different ESG fragments in a time frame. The arrows show the transmission period for each fragment. The ‘Service’ fragment is transmitted starting at t=t0 and the transmission continues until t=tn. Different ESG fragments ‘Schedule 1’, . . . , ‘Schedule 4’ are also transmitted. The transmission of ESG fragment ‘Schedule 1’ is started at t=t0 and is continued until t=t2. Correspondingly the transmission of ESG fragment ‘Content 1’ is started at t=t0. The transmission times for ESG fragments may vary. For example one ESG fragment ‘Content’ may describe a daily program, wherein the corresponding fragment may be transmitted continuously.

In another example, a latest time is provided with the ESG fragment or group of ESG fragments. In this example, the latest time indicates the latest time when the transmission of the ESG fragment may be started. Prior to this time, the ESG fragment may be considered valid and may be maintained in a memory of the receiver or subscriber terminal. Hence, if the ESG fragment is not present in a service guide transmission during this time, the corresponding ESG fragment may still be maintained in memory. However, when the latest time is reached, then the receiver or subscriber terminal may determine that the ESG fragment is no longer valid if the ESG fragment is no longer transmitted. In that case, the receiver may delete the ESG fragment from memory. Otherwise, if the ESG fragment continues to be transmitted after the latest time, then the receiver may continue to maintain the ESG fragment in memory. In this case the receiver may determine that the ESG fragment and corresponding program or service are valid.

In addition, ESG fragments corresponding to a program or service may be delivered at different times and over different channels. The different ESG fragments corresponding to a same program or service may be identified by a receiver as ESG fragments pertaining to a particular service guide. For example, the different ESG fragments may contain the same identification so that they may be identified as related to the same program, service or service guide. In one example, the service guide can be uniquely identified with an IP platform ID (e.g., from PSI/SI) and the service guide provider may be identified by a unique URI (e.g., from ESG bootstrap descriptors). Also, service guides may be located based on network ID or terminal ID as well.

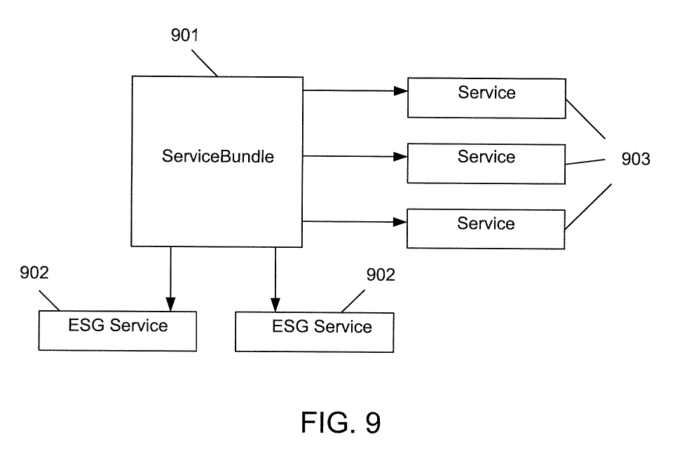

Likewise, service guides may be delivered to a select group of customers. For example, the ESG data may be delivered only to subscribing customers—i.e., customers who have subscribed to the particular service or program. In this example, the terminal application in the receiver may identify a service or program through an identifier of the service or program. Alternatively, an ESG fragment may be associated with permitting the purchase of the service in a service bundle. In this example, the service bundle can include any type of service, for example, specific ESG services or any other type of service. FIG. 9 illustrates an example of a service bundle 901 providing multiple services including ESG services that can be described as separate services. The ESG services 902 of FIG. 9 are delivered in a similar way as the ordinary services and programs 903. Examples of such ESG services 902 can be an ESG that comprises only available and future sports programs or an ESG comprising only information (schedules and content description) relating to music programs. The service bundle in FIG. 9 comprises three normal services and two ESG services.

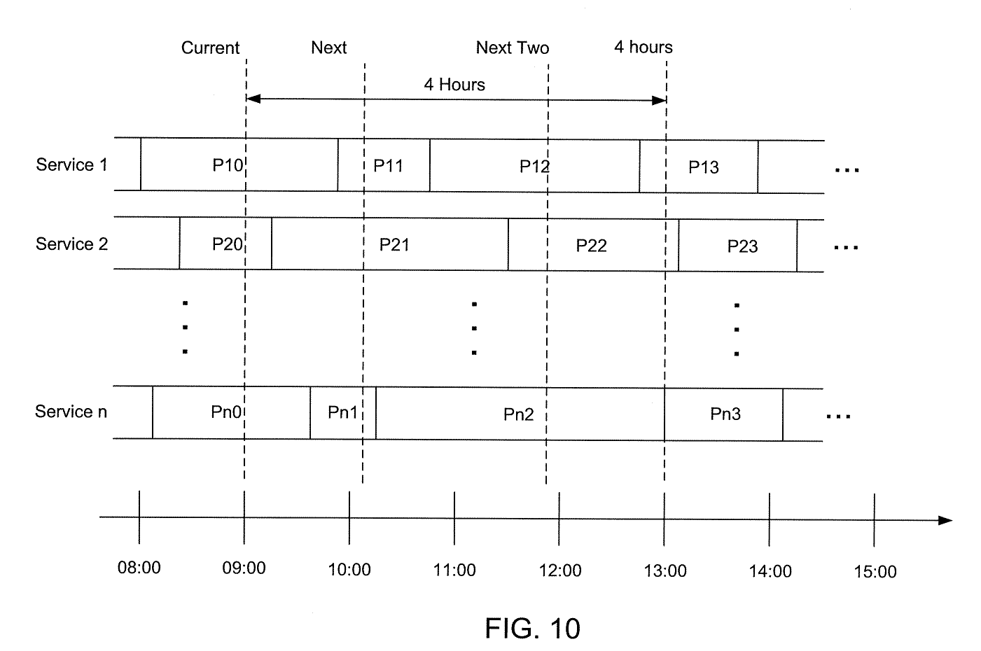

FIG. 10 illustrates an example of transmission of ESG fragments over a period of time. In this example, each of the n services illustrated are associated with a plurality of ESG fragments associated with the services being transmitted over a period of time. At a current time, ESG data being transmitted contains information pertaining to the illustrated programs such as P10 of Service 1, P20 of service 2, . . . , Pn0 of service n, etc. As time progresses to the “next” time, different ESG fragments may be transmitted for each of the corresponding programs or services as illustrated. In this example, at the “next” time, the service guide may include ESG fragments providing information pertaining to P11, P21, . . . , Pn1, of each of the services, respectively. In a subsequent (next two) service guide, ESG fragments providing information pertaining to P11, P12, P21, P22, . . . , Pn1, Pn2 of the respective services may be transmitted. In the service guide at 4 hours, ESG fragments may include those fragments providing information pertaining to P10, P11, P12, P13, P20, P21, P22, . . . , Pn0, Pn1, and Pn2 of the respective services.

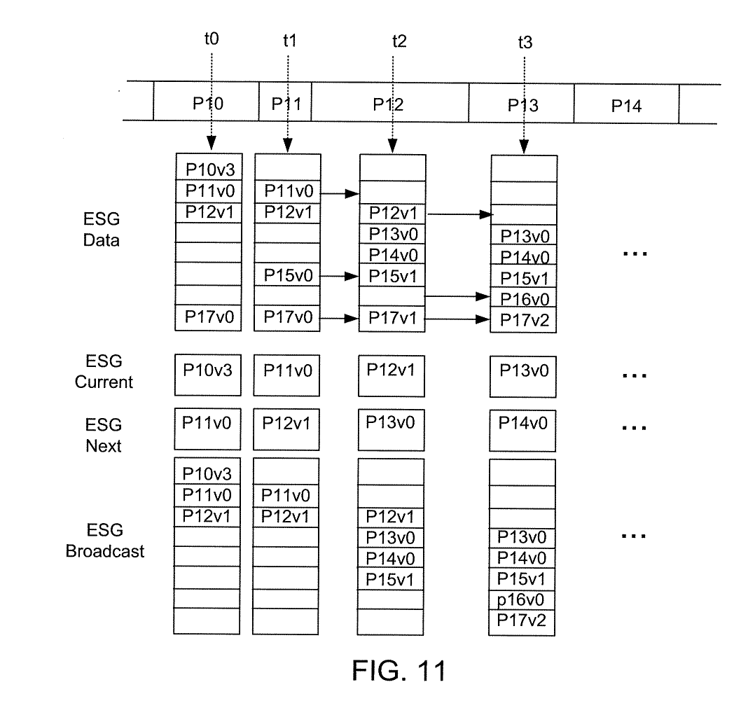

FIG. 11 is a diagram illustrating an example of transmitting ESG fragments of a service.

In this example, the programs of service 1 are illustrated as P10-P14. These programs may have a variety of forms. For example, the programs may be newscasts, movies, live sports broadcasts, television programs, etc. Each of the programs may have a corresponding ESG fragment or group of ESG fragments. The corresponding ESG fragment(s) may carry information pertaining to the respective program. For example, an ESG fragment may provide information on the content of the program, the timing of the program, subscription information or payment information, etc. In this example, each of the ESG fragments may also provide information on a version of the program such that updated information pertaining to the program may be provided in the corresponding ESG fragment.

As the example of FIG. 11 illustrates, at time t=t0, the ESG data includes ESG fragments P10v3, P11v0, P12v1, and P17v0. At time t=t1, a new ESG fragment is added to the ESG data, namely, Pl5v0. Also, an ESG fragment previously included in the ESG data at time t=t0 is no longer transmitted in the ESG data at time t=t1 (i.e., P10v3). Hence, ESG fragment P10v3 is deleted from the receiver memory.

At time t=t2, two additional ESG fragments, namely, P13v0 and P14v0 are added to the ESG data. Also, P15v0 and P17v0 transmitted in the ESG data at time t=t1 have been updated at time t=t2. As FIG. 11 illustrates, a new version of each ESG fragment is included in the ESG data as P15v1 and P17v1, respectively, at time t=t2. Therefore, the new versions of the ESG fragments replace the respective old versions in the receiver's memory. Also, ESG fragment P11v0, previously included in the ESG data at time t=t0 and t=1 is no longer included in the ESG data at time t=t2. hence, ESG fragment p11v0 is deleted. At time t=t3, a new ESG fragment P16v0 is included in the ESG data. Also, a new version of P17v1 (i.e., P17v2) is also included in the ESG data. Therefore, P17v2 replaces P17v1 and P12v1 is deleted. Also, as illustrated in the example of FIG. 11, ESG Current and ESG Next are selected based on the ESG data created and stored at the transmitter. For example, at t1, P11v0 is selected as the ESG Current and P12v1 is selected as ESG Next from the ESG data. Likewise, selected ESG fragments may be selected for broadcast. This selection may be based on a variety of criteria such as available bandwidth, etc. In this example, P17v1 is included in the ESG data at t=t2 but is selected for broadcast at the later time t=t3. The receiver receives ESG fragments that are broadcast in ESG broadcast.

Hence, in this example, the ESG fragments are continuously sent to a receiver. If new versions of previously stored ESG fragments are encountered, then the new versions replace the old (stored) versions. If a previously stored ESG fragment is no longer being transmitted in ESG data, then the previously stored ESG fragment is deleted from memory. If a new ESG fragment is included in the ESG data being transmitted, then the new ESG fragment is stored in memory. This process is described in more detail below.

In another example, the ESG fragments may carry additional information. For example, the ESG fragments may include validity information. This may include, for example, information pertaining to the start time of the corresponding service/program, end or stop times of the corresponding service/program or length of time for validity. Also, the ESG fragments may include additional information such as the latest time that the ESG fragment is to be transmitted. If the ESG fragment includes information about the latest time of transmission, then the receiver can determine if the ESG fragment is valid based on the time of transmission. For example, if the ESG fragment includes information that indicates that the latest time of transmission of the ESG fragment is at time t=t0 but the ESG fragment is received at a later time t=t0 then the ESG fragment may be determined to be invalid.

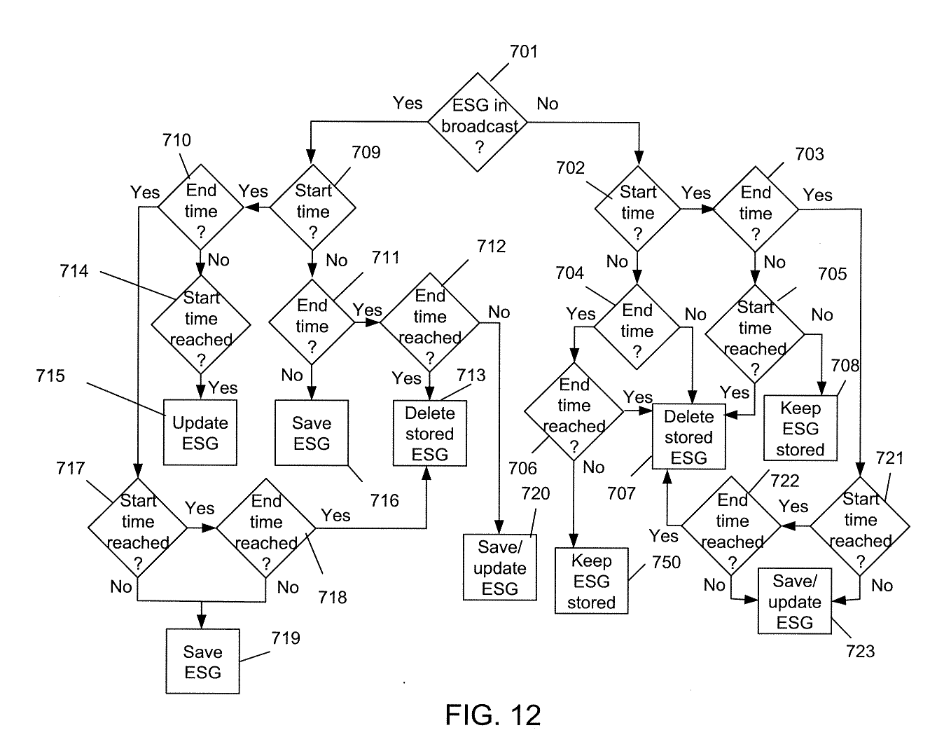

FIG. 12 is a flowchart illustrating an example of a method for managing ESG fragments. In this example, an ESG fragment is determined to be transmitted within ESG data in a service guide transmission (STEP 701). The ESG fragment may contain information pertaining to a start time and/or stop time of a corresponding service or program. If the received ESG fragment is present in the transmission (the “YES” branch of STEP 701) and does not contain either a parameter indicating the start time or a parameter indicating the stop time of the corresponding service or program (the “NO” branch of STEP 709 and the “NO” branch of STEP 711), then the ESG fragment may be valid (no time validity information is provided) and is stored in memory (STEP 716) if the ESG fragment is not already stored in memory.

If the received ESG fragment is present in the transmission (the “YES” branch of STEP 701) and also contains a parameter indicating a valid start time (the “YES” branch of STEP 709) and stop time (the “YES” branch of STEP 710) of the corresponding service or program, then the ESG fragment is stored in memory (STEP 719) if either the current time is prior to the start time (indicating that the ESG fragment is still valid because the program or service has not yet occurred) or if the current time is after the start time but prior to the stop time (indicating that the ESG fragment is still valid because the corresponding program or service, although already commenced, has not yet terminated). Otherwise, if the current time is after the stop time (the “YES” branch of STEP 717 and the “YES” branch of STEP 718), then the corresponding ESG fragment stored in memory is deleted (STEP 713) because the ESG fragment is obsolete (the program or service is already terminated).

If the received ESG fragment is present in the transmission (the “YES” branch of STEP 701) and also contains a parameter indicating a valid start time (the “YES” branch of STEP 709) but does not contain a parameter indicating a valid stop time (the “NO” branch of STEP 710), then the ESG fragment may be updated (STEP 715) if the current time is after the start time (the “YES” branch of STEP 714). In this example, the current time is after the start time of the corresponding program or service which indicates that the program or service is in progress. Therefore, if the ESG fragment represents an updated version of the ESG fragment, the old version of the ESG fragment is updated in memory. If the start time has not yet been reached, then the ESG fragment is also stored in memory if the ESG fragment has not previously been stored in memory. In this case, the program or service has not yet started but is still valid. Therefore, the corresponding ESG fragment is stored.

If the received ESG fragment is present in the transmission (the “YES” branch of STEP 701) and also contains a parameter indicating a valid stop time (the “YES” branch of STEP 711) but no parameter indicating a valid start time (the “NO” branch of STEP 709), then the corresponding stored ESG fragment is deleted (STEP 713) if the current time is after the valid stop time (the “YES” branch of STEP 712). In this case, the current time is after the valid stop time and therefore, the corresponding program or service has been terminated. Therefore, the ESG fragment is no longer valid and is deleted (STEP 713). Otherwise, if the stop time has not yet been reached (the “NO” branch of STEP 712), then the corresponding program or service is still valid. In this case, the ESG fragment is stored in memory if the ESG fragment has not been previously stored (STEP 720). If the ESG fragment has a higher version than the corresponding ESG fragment stored in memory, then the ESG fragment in memory is updated with the new ESG fragment (STEP 720).

Also in this example, an ESG fragment may be stored in memory but the corresponding ESG fragment may not be received in an ESG transmission (the “NO” branch of STEP 701). In this example, if the stored ESG fragment does not contain either a parameter indicating a valid start time or a valid stop time (the “NO” branch of step 702 and the “NO” branch of step 704), then, in this example, the stored ESG fragment may be deleted. In this example, the transmission no longer includes the ESG fragment in the ESG data. Hence, the receiver may determine that the ESG fragment is obsolete or otherwise not valid and delete the corresponding stored ESG fragment from memory.

If the stored ESG fragment contains a parameter indicating a valid start time but does not contain a parameter indicating a valid stop time (the “YES” branch of STEP 702 and the “NO” branch of STEP 703), then the receiver may continue to maintain the ESG fragment in memory if the current time is prior to the start time (the “NO” branch of step 705 and STEP 708). In this case, the corresponding program or service has not yet commenced. Therefore, the corresponding ESG fragment may be determined to be valid and is therefore maintained in memory. Otherwise, if the current time is after the start time (the “YES” branch of STEP 705), then the corresponding program or receiver has commenced. Therefore, the corresponding ESG fragment may be determined to be invalid and may be deleted from memory (the “YES” branch of STEP 705 and STEP 707). Also in this example, if the stored ESG fragment contains both a parameter indicating a valid start time and a valid stop time (the “YES” branch of STEP 702 and the “YES” branch of STEP 703), then the ESG fragment is maintained in memory or updated as necessary (STEP 723) if the start time has not been reached (the “NO” branch of STEP 721) or if the stop time has not been reached (the “NO” branch of STEP 722). Otherwise, the stored ESG fragment may be deleted (the “YES” branch of STEP 721 and the “YES” branch of STEP 722 and STEP 707).

If the stored ESG fragment includes a parameter indicating a corresponding valid stop time of the corresponding program or service but no parameter indicating a valid start time (the “NO” branch of STEP 702 and the “YES” branch of STEP 704), then the stored ESG fragment is deleted (STEP 707) if the current time is after the valid stop time (the “YES” branch of STEP 706). Otherwise, if the current time is prior to the valid stop time (the “NO” branch of STEP 706), then the ESG is stored (STEP 750).

In any of these examples, the receiver may further delete ESG fragments that do not contain parameters indicating a valid start time and valid stop time corresponding to a program or service after a predetermined period of time, if desired. For example, a period of time may be determined in which the ESG fragment and corresponding program or service may be considered invalid or terminated. In such a case when the pre-determined time period has elapsed, the ESG fragment may be deleted if there are no other reasons to maintain the ESG fragment in memory. The ESG fragment may be continued to be maintained in memory if, for example, there is a continuing need for the description of stored content.

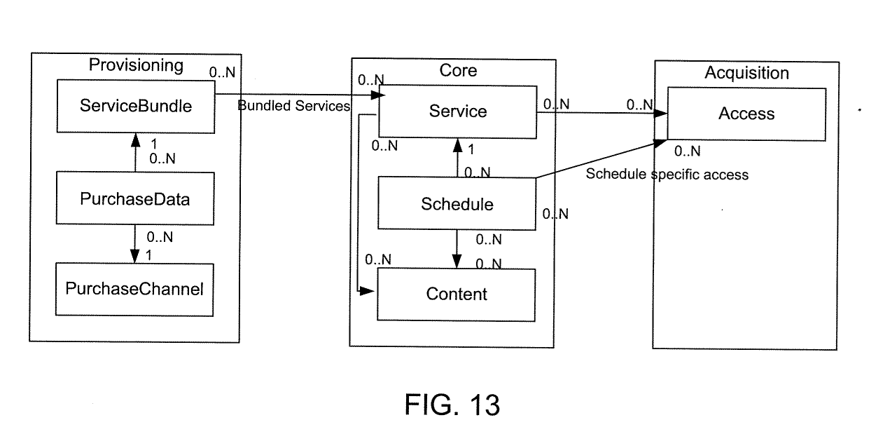

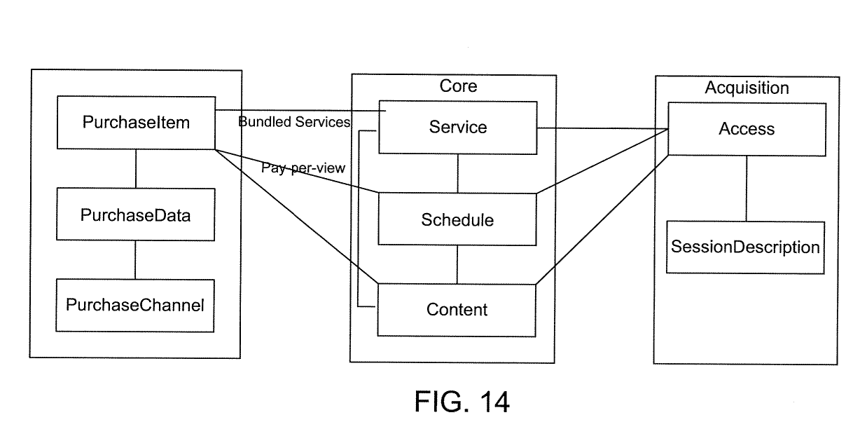

FIGS. 13 and 14 illustrate elements that may be transmitted in ESG fragments and interdependencies of ESG fragments. In FIG. 13, an example of an ESG data model is illustrated according to DVB or CBMS. FIG. 14 is an example of an ESG data model according to OMA BCAST. The provisioning block of FIG. 13 contains elements ServiceBundle, PurchaseData and PurchaseChannel. The ESG data model of FIG. 14 illustrates an example in which elements “PurchaseItem”, “PurchaseData” and “PurchaseChannel” are provided. The Element “ServiceBundle” describes a set of services that may be purchased or accessed as a single item. The Element “PurchaseData” may comprise information on the services such as price, subscription periods, etc for each purchase item. The Element “PurchaseChannel” may comprise information on how to purchase the purchase item or “serviceBundle”. For example, the “PurchaseChannel” may include information on how and from where to purchase the purchase item or “ServiceBundle.”

Also as illustrated in FIG. 13 and in FIG. 14, the Core element may contain a “Service” element, “Schedule” element and “Content” element. Each of these elements describe the single available service. Access information to access the service may be provided in an “Access” element as illustrated in FIG. 13 and FIG. 14. For example, the “Access” element may provide information on access information such as IP addresses, port numbers and session descriptors. FIG. 14 further illustrates a “SessionDescription” element for describing the session.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended embodiments.

1. An apparatus comprising:
an input for receiving data to be included in an ESG fragment for transmission, the data including timing information, the timing information including at least one of a valid start time and a valid stop time for a program or service associated with the ESG fragment;
a processor configured to perform the steps of:
generating the ESG fragment based on the data received at the input, and inserting the timing information into the ESG fragment; and
an output for delivering the ESG fragment, including the timing information, to a subscriber terminal.

2. An apparatus comprising:
an input for receiving an ESG fragment associated with a program or service, the ESG fragment including at least one of a start time and a stop time for the program or service;
a memory storage; and
a processor configured to perform the following steps:
comparing the at least one of a start time and a stop time for the program or service with a current time; and
trying to identify an ESG fragment that is stored in the memory storage and that corresponds to the received ESG fragment; and
determining whether to delete a stored ESG fragment based on the comparing step and the trying-to-identify step.

3. A method comprising:
receiving an ESG fragment, the received ESG fragment including a parameter indicating at least one of a start time and a stop time of a program or service corresponding to the received ESG fragment;
determining a match between the received ESG fragment and an ESG fragment previously stored in the receiver; and
deleting the previously stored ESG fragment if the received ESG fragment's parameter indicates a stop time and if a current time is after the indicated stop time, otherwise saving the received ESG fragment.

4. A method comprising:
receiving an ESG fragment wherein the ESG fragment includes neither a start time nor a stop time of a program or service corresponding to the received ESG fragment;
determining a match between the received ESG fragment and an ESG fragment previously stored in the receiver;
determining a version of the received ESG fragment; and
replacing the stored ESG fragment with the received ESG fragment based on the version of the received ESG fragment.

5. The method of claim 4 wherein the replacing step comprises replacing the stored ESG fragment with the received ESG fragment if the version of the received ESG fragment is greater than a version of the stored ESG fragment, otherwise deleting the previously stored ESG fragment.

6. The method of claim 4 wherein the determining step comprises determining that the version of the received ESG fragment is greater than a version of the stored ESG fragment.

7. A method comprising:
storing an ESG fragment in memory, the stored ESG fragment including a start time and a stop time of a program or service corresponding to the stored ESG fragment;
determining the absence of the ESG fragment in a received service guide transmission; and
deleting the stored ESG fragment from memory if a current time is greater than the start time and the stop time, otherwise maintaining the ESG fragment in memory.

8. A method comprising:
storing an ESG fragment in memory, the stored ESG fragment including one of a start time and a stop time of a program or service corresponding to the stored ESG fragment;
determining the absence of the ESG fragment in a received service guide transmission; and
deleting the ESG fragment from memory based on the start time.

9. The method of claim 8 wherein the ESG fragment includes the start time and wherein the deleting step comprises maintaining the stored ESG fragment in memory if the current time is less than the start time, otherwise deleting the stored ESG fragment from memory.

10. A method comprising:
storing an ESG fragment in memory, the stored ESG fragment including neither a start time nor a stop time for a program or service corresponding to the stored ESG fragment;
determining the absence of the ESG fragment in a received service guide transmission; and
deleting the stored ESG fragment from memory based on the determining step.

11. A method comprising:
receiving an ESG fragment, the received ESG fragment including at least one validity parameter for the received ESG fragment;
determining a match between the received ESG fragment and an ESG fragment previously stored in the receiver; and
deleting the previously stored ESG fragment if the received ESG fragment's validity parameter indicates that the received ESG fragment is invalid, otherwise saving the received ESG fragment.

12. The method of claim 11, wherein the received ESG fragment's validity parameter specifies a latest time that the ESG fragment is to be transmitted.

13. An apparatus comprising:
means for receiving an ESG fragment, the received ESG fragment including a parameter indicating at least one of a start time and a stop time of a program or service corresponding to the received ESG fragment;
means for determining a match between the received ESG fragment and an ESG fragment previously stored in the receiver; and
means for deleting the previously stored ESG fragment if the received ESG fragment's parameter indicates a stop time and if a current time is after the indicated stop time, otherwise saving the received ESG fragment.

14. An apparatus comprising:
means for receiving an ESG fragment wherein the ESG fragment includes neither a start time nor a stop time of a program or service corresponding to the received ESG fragment;
means for determining a match between the received ESG fragment and an ESG fragment previously stored in the receiver;
means for determining a version of the received ESG fragment; and
means for replacing the stored ESG fragment with the received ESG fragment based on the version of the received ESG fragment.

15. The apparatus of claim 14 wherein the means for replacing comprises means for replacing the stored ESG fragment with the received ESG fragment, if the version of the received ESG fragment is greater than a version of the stored ESG fragment, and, otherwise, deleting the previously stored ESG fragment.

16. The apparatus of claim 14 wherein the means for determining comprises means for determining that the version of the received ESG fragment is greater than a version of the stored ESG fragment.

17. An apparatus comprising:
means for storing an ESG fragment in memory, the stored ESG fragment including a start time and a stop time of a program or service corresponding to the stored ESG fragment;
means for determining the absence of the ESG fragment in a received service guide transmission; and
means for deleting the stored ESG fragment from memory, if a current time is greater than the start time and the stop time, and, otherwise, maintaining the ESG fragment in memory.

18. An apparatus comprising:
means for storing an ESG fragment in memory, the stored ESG fragment including one of a start time and a stop time of a program or service corresponding to the stored ESG fragment;
means for determining the absence of the ESG fragment in a received service guide transmission; and
means for deleting the ESG fragment from memory based on the start time.

19. The apparatus of claim 18 wherein the ESG fragment includes the start time and wherein the means for deleting comprises maintaining the stored ESG fragment in memory, if the current time is less than the start time, and, otherwise, deleting the stored ESG fragment from memory.

20. An apparatus comprising:
means for storing an ESG fragment in memory, the stored ESG fragment including neither a start time nor a stop time for a program or service corresponding to the stored ESG fragment;
means for determining the absence of the ESG fragment in a received service guide transmission; and
means for deleting the stored ESG fragment from memory based on the determining step.

21. An apparatus comprising:
means for receiving an ESG fragment, the received ESG fragment including at least one validity parameter for the received ESG fragment;
means for determining a match between the received ESG fragment and an ESG fragment previously stored in the receiver; and
means for deleting the previously stored ESG fragment if the received ESG fragment's validity parameter indicates that the received ESG fragment is invalid, and, otherwise, saving the received ESG fragment.

22. The apparatus of claim 21, wherein the received ESG fragment's validity parameter specifies a latest time that the ESG fragment is to be transmitted.
